(19) United States
(12) Patent Application Publication
(10) Pub. No.: US 2005/0216284 A1
(43) Pub. Date: Sep. 29, 2005

(54) Monetized information exchange

(76) Inventor: Carlos Mario Candeloro, Manhattan Beach, CA (US)

Correspondence Address: Carlos M. Candeloro, 1601 N. Sepulveda Blvd. 239, Manhattan Beach, CA, 90266, US

(21) Appl. No.: 10/810,018

(22) Filed: Mar. 26, 2004

(51) Int. Cl. G06F 17/60

(52) U.S. Cl. 705/1

(57) ABSTRACT

Systems, methods and databases for the exchange of information offering advantages over current systems and methods are provided.

### FIELD OF THE INVENTION

The present invention relates to economic information exchange.

### BACKGROUND OF THE INVENTION

The information age has arrived. In its wake, flooded e-mail servers around the world struggle to keep up with the torrent of unwanted information being indiscriminately hurled at anyone having an electronic address.

An individual's time is a scarce resource, and today's electronic mail has left it at the mercy of spammers. When unwanted information can be deposited in an individual's electronic mail box, the individual must spend his or her time, generally free of charge to anyone, to deal with the information. To avoid having their mailboxes' capacity overrun by unwanted e-mails, netizens have been forced to flee or adopt a defense of last resort: changing their e-mail address as soon as spammers catch up. The shortening periodicity of the cycle has relegated many netizens to a nomadic electronic existence. Said pervasive nomadic existence entails large costs to individuals and society. Among them, it prevents the accrual of benefits associated with permanence, including, for example, the development of a recognizable long term electronic identity while it also disfavors investments that could be made if the costs associated with being at a fixed location were not so high. In other words, improvement of property has been prevented by a constant assault by marauders driven by the free allocation of someone else's time.

Large entities, who can't run to escape the barrage, have had to bear the costs largely unassisted. Generally based on pattern recognition algorithms that block e-mails fitting certain profiles, screening procedures have been put in place by many such entities to filter the torrent of unwanted e-mail being sent to their servers. But there is no end in sight to the downwardly spiraling arms race pitting the creativity of spammers against the ingenuity of filter programmers. And the deleterious side effects caused by filtering algorithms based on e-mail content, origin and like, can be costly. Amongst the most pernicious costs are those related to blocking valuable e-mails.

Regular e-mail also involves other unaccounted costs that weigh heavily on many individuals and organizations, including the unauthorized use of e-mail by employees, the risk of contagion by ever replicating viruses, worms and other electronic life forms parasitizing software ubiquitous in today's networks, the inability to properly account for, and thus optimally allocate, the costs and benefits associated with the transfer, dissemination and deletion of information, among others.

Accordingly, there is a need for a system and method to associate the transfer of units of value with a post.

### SUMMARY OF THE INVENTION

The present invention relates generally to a post and a system and method for transferring units of value therewith and other components enabling the practice of the present invention.

### BRIEF DESCRIPTION OF THE DRAWINGS

FIG. 1 is a diagrammatic representation of a generic system that enables practicing an embodiment of the present invention.

FIG. 2 is a diagrammatic representation of a database design that enables a system in accordance with an embodiment of the present invention.

FIG. 3 is a diagrammatic representation of an exemplary embodiment of a member table in accordance with an embodiment of the present invention enabling an embodiment of a database in accordance with the present invention.

FIG. 4 is a diagrammatic representation of an exemplary embodiment of a post table in accordance with an embodiment of the present invention enabling an embodiment of a database in accordance with the present invention.

FIG. 5 is a diagrammatic representation of an exemplary embodiment of an addressee table in accordance with an embodiment of the present invention enabling an embodiment of a database in accordance with the present invention.

FIG. 6 is a diagrammatic representation of an exemplary embodiment of a member inbox table in accordance with an embodiment of the present invention enabling an embodiment of a database in accordance with the present invention.

FIG. 7 is a diagrammatic representation of an exemplary embodiment of a transaction table in accordance with an embodiment of the present invention enabling an embodiment of a database in accordance with the present invention.

FIG. 8 is a flow diagram of a routine in accordance with an embodiment of the present invention that enables setting mailbox rules in accordance with an embodiment of the present invention.

FIG. 9 is a flow diagram of a routine in accordance with an embodiment of the present invention that enables processing information linked to a proposal in accordance with an embodiment of the present invention.

FIG. 10 is a flow diagram of a routine in accordance with an embodiment of the present invention that enables post distribution in accordance with an embodiment of the present invention.

FIG. 11 is a flow diagram of a routine in accordance with an embodiment of the present invention that enables post access in accordance with an embodiment of the present invention.

FIG. 12 is a flow diagram of a routine in accordance with an embodiment of the present invention that enables disposal of a post in accordance with an embodiment of the present invention.

FIG. 13 is a flow diagram of a routine in accordance with an embodiment of the present invention that enables replying to a post in accordance with an embodiment of the present invention.

FIG. 14 is an exemplary diagram illustrating a generic combination of input fields that may be used to generate a post.

FIG. 15 is an exemplary representation illustrating an interface diagram including a combination of input fields and other information that will find use as a confirmation and payment form in accordance with an embodiment of the present invention.

FIG. 16 is an exemplary representation illustrating an interface diagram including a combination of input fields and other information that will find use as a mailbox in accordance with an embodiment of the present invention.

FIG. 17 is an exemplary representation illustrating an interface diagram including a combination of fields and other information that will find use as an account page in accordance with an embodiment of the present invention.

FIG. 18 is an exemplary representation illustrating an interface diagram including a combination of input fields and other information that will find use in generating a post in accordance with an embodiment of the present invention.

FIG. 19 is an exemplary representation illustrating an interface diagram including a combination of input fields and other information that will find use as a confirmation and payment form in accordance with another embodiment of the present invention.

FIG. 20 is an exemplary representation illustrating an interface diagram including a combination of input fields and other information that will find use as a mailbox in accordance with another embodiment of the present invention.

FIG. 21 is an exemplary representation illustrating an interface diagram including a combination of input fields and other information that will find use as an account page in accordance with another embodiment of the present invention.

### DETAILED DESCRIPTION OF THE INVENTION

A post and a system and method for transferring units of value therewith are described. In the following description, for purposes of explanation, numerous specific details are set forth in order to provide a thorough understanding of one or more embodiments of the present invention. As will be evident to those of skill in the art, certain embodiments of the present invention may be practiced without these specific details.

Unless otherwise specified or required by the context, as used herein the term “unit based value” or “unit of value” generally is meant to include anything that may be counted or accounted for, and that may have a value to somebody. It may generally include, for example, monetary values, including currency, cash, credits, and the like, frequent flier miles, and the like, frequent buyer points, and the like, commission points, and the like, securities, and the like, votes, and the like, unit based value for the transfer of information, and the like.

Unless otherwise specified or required by the context, as used herein the term “sender” means any entity having posted or intending to post information such that it may be accessed by an addressee.

Unless otherwise specified or required by the context, as used herein the term “addressee” or “intended recipient” means any entity having an account, or the like, to which a post may be posted in accordance with the present invention. Generally, an account also enables the transfer of units of value to and from the addressee.

Unless otherwise specified or required by the context, as used herein the term “recipient” generally means an entity that has received a post.

Unless otherwise specified or required by the context, as used herein the verb “to post” means that information, or the like, is stored and made available through an account, or the like, to an addressee.

Unless otherwise specified or required by the context, as used herein the noun “post” means information including or linked to an addressee.

In one embodiment, the present invention may be described in terms of a system. Generally, the system may be implemented in any effective manner. In one embodiment, the system includes an element for storing data, a processor and a direct or indirect connection to the outside world. The system is set up such that it may perform a function or set of functions in accordance with an embodiment of the present invention.

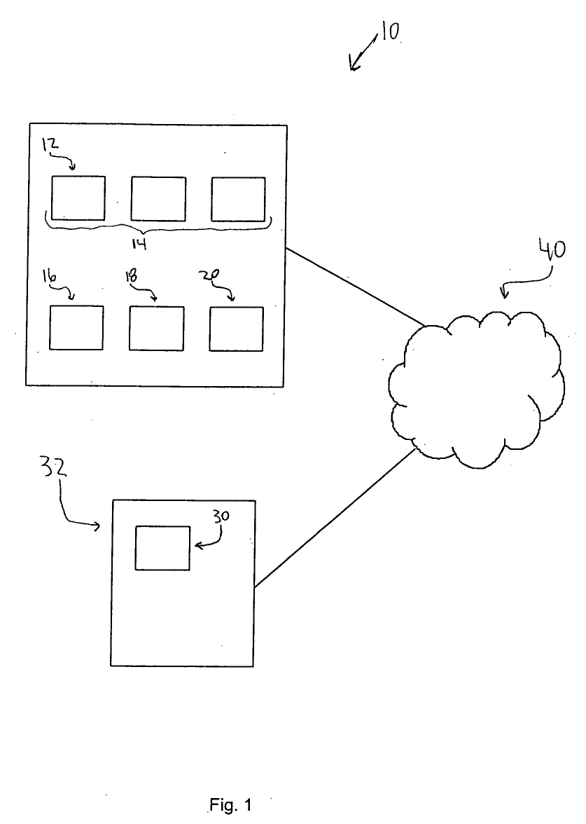

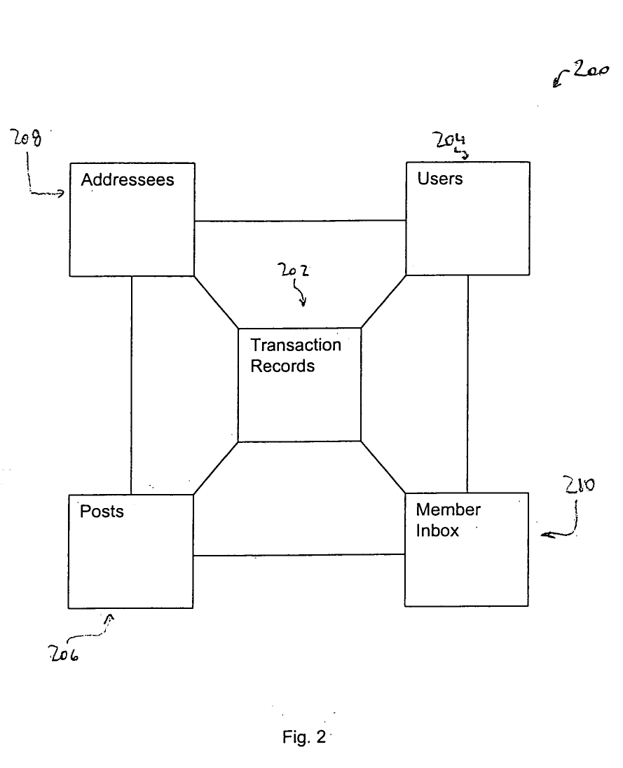

FIG. 1 is a block diagram illustrating an exemplary accounting and information exchange facility 10. While an exemplary embodiment of the present invention is shown in the figure, in accordance with the present invention any effective form of information exchange facility may be used. A facility in accordance with the present invention generally will include one 12 or more 14 servers. Generally the server or servers are mark-up language pages 16, e.g., HTML, XML, and the like, database 18, e.g., MySQL, or the like, and scripting language 20, e.g., PHP, or the like, capable.

An accounting and information exchange system 10 in accordance with the present invention may be accessed in any effective manner. For example, in one embodiment, a client program 30, such as a browser, cell phone interface, or the like, executes on a client machine 32 and accesses the system 10. Any effective client machine may be used. The client may access the system in any effective manner. For example, in one embodiment the client accesses the system via a network 40. Any effective network may be used to access the information exchange facility 10 including, for example, the internet, a wide area network (WAN), a local area network (LAN), a wireless network (e.g., a cellular network), the Old Plain Telephone Service (OPTS) network.

In accordance with one embodiment of the present invention members of the information exchange facility generally have an account. And generally may operate as a sender, addressee, or both. Generally non-members do not have an account with the information exchange facility. And generally non-members operate as senders.

In accordance with one embodiment of the present invention a system enables the transfer of units of value in accordance with an accepted proposal functionally linked to information.

The information necessary to effectuate the present invention may be stored in any effective manner, including in a database, or the like, and/or files, and the like. When a database is used, it may be implemented any effective manner. The database may, in one embodiment, be implemented as a relational database, wherein it includes one or more tables having entries, or records, that are linked by indices and keys. In an alternative embodiment, the database may be implemented as a collection of objects in an object-oriented database.

As will be recognized by those skilled in the art, if a database is used to implement the present invention, it may have any effective design. The field or set of fields, entries, and the like, described throughout the description of the present invention may be in the same table, or the like, or distributed throughout one or more tables, as long as there is an effective manner of functionally linking the information between said field or set of fields as necessary. In addition, more fields, including timestamps, and the like, may be added as necessary. Some embodiments of the present invention include some but not all of the functionality described herein. In case a table, field, entry or the like, is not necessary in the implementation of an embodiment of the present invention, the table, field, entry or the like may be omitted.

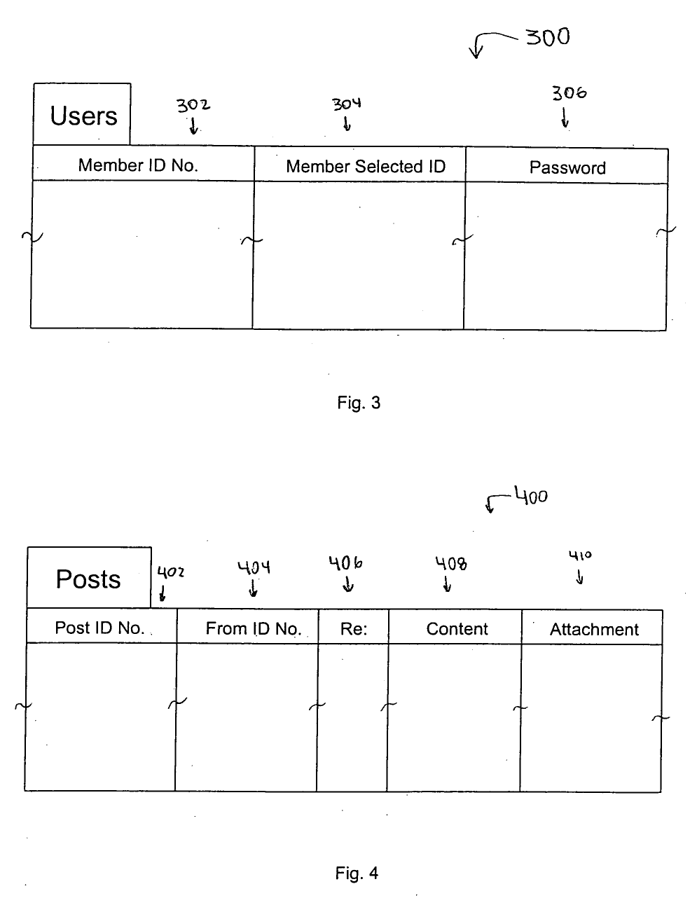

In one embodiment, a database of the present invention includes a user table, set of tables, and/or fields that may contain, inter alia, a record, or the like, for each of the members of an information exchange facility, system, or the like. A user information table that includes more detailed information about each user may be linked to the user table. FIG. 3 is a diagrammatic representation of an exemplary embodiment of a member table 300 which may be populated with records, or entries, for each member of the information exchange facility. The member table 300 may include a member identifier field or set of fields 302 for storing a unique identifier for each member. The table 300 may also include an information exchange facility identity field or set of fields 304 for storing an identity for each member. In one embodiment, the identity stored in field or set of fields 304 is the identity that would be used by a sender to address a post to a member. In one embodiment, the identity stored in field or set of fields 304 is also the identity used by members to access their accounts (e.g., to log in). In an alternative embodiment, not shown in the figure, the member table 300 may also include an information exchange facility login field or set of fields for storing a login identity for each member. A member's login identity may be the same or different from the member's information exchange facility identity 304. The table 300 may also include a member password field or set of fields 306 for storing a password for each member. In one embodiment, the password is encrypted prior to being stored. The table 300 may also include a member setting field, or set of fields for storing a member's settings (not shown). In one embodiment, the settings may include, inter alia, inbox rules in accordance with the present invention. In another embodiment, a member's inbox rules in accordance with the present invention are in a separate table, or the like, that is functionally linked to said member's other information.

In one embodiment, the database includes a table, set of tables, and/or fields for storing post information. The information may be directly or indirectly associated and/or linked to a user table, or the like. In one embodiment, the table further includes information regarding a sender. In another embodiment, information regarding senders is held in a separate table which may be directly or indirectly linked to the table. In one embodiment, the table further includes information regarding an addressee or set of addressees. In another embodiment, information regarding an addressee or set of addressees is held in a separate table(s) which may be directly or indirectly linked to the table. In another embodiment, the table further includes an attachment or attachments or a link thereto. In another embodiment, information regarding attachments or attachments themselves is held in a separate table(s) which may be directly or indirectly linked to the table. FIG. 4 is a diagrammatic representation of an exemplary embodiment of a post table 400 which may be populated with contents of postings made to information exchange facility's members. The post table 400 may include a post identifier field or set of fields 402 for storing a unique identifier for each posting. The table 400 may also include a field or set of fields 404 for storing the identity of the sender. The table 400 may also include a field or set of fields 406 for storing a string, text, or the like, generally known as the subject or “Re:” line when writing letters, e-mail, and the like. The table 400 may also include a field or set of fields 408 for storing text and other information, including sound, graphic, java, and other information. The table 400 may also include a field or set of fields 410 for storing attachments or noting the presence or absence of attachments. In the latter case, the attachments, if present, may be stored in a manner in which they may be linked to the posting which included said attachment or set of attachments.

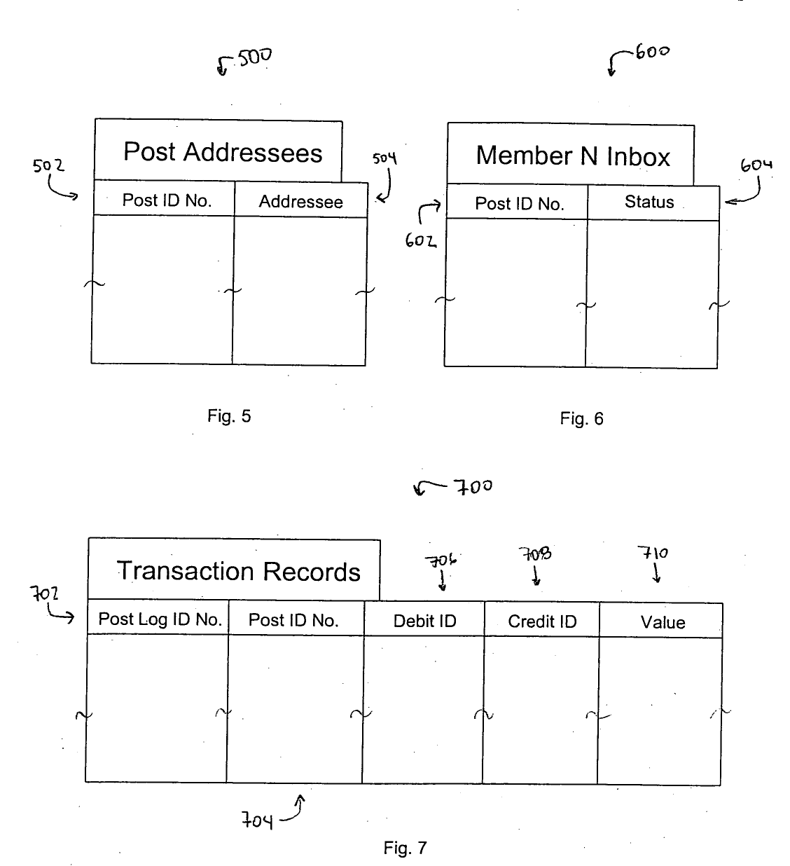

FIG. 5 is a diagrammatic representation of an exemplary embodiment of a table 500 which may be populated with records, or entries, of an addressee or set of addressees linked to a post sent to an information exchange facility's member or set of members. The addressee table 500 may include a post identifier field or set of fields 502 that may link it to a unique identifier of a post, e.g., 402. The table 500 may also include a field or set of fields 504 for storing the identity of the addressee, e.g., 302, 304, or the like, or set of addressees for the specified posting. The addressee or set of addressees may be divided, as is conventional in the art, according to main addressee or set of addressees (“To” field); carbon copy addressee or set of addressees (“Cc” field) and/or blind carbon copy addressee or set of addressees (“Bcc” field) (not shown). These, as the other embodiments of the present invention, may be present in individual fields, table, set of tables, or other effective manner.

In one embodiment, the database includes a table, set of tables, and/or fields that keep track of the status of a post. For example, whether it's been accessed, whether it's been replied to, whether it's been deleted, and the like. While any effective manner may be used to keep track of the status of postings, in one embodiment this may be accomplished by including in the database an inbox table, set of tables, and/or fields, or the like, associated with each member. The inbox table, or the like, may be implemented in any effective manner. In one embodiment, it includes a first field that links to a post. The inbox table, set of tables, and/or fields, or the like, may also include a second field with a code, or the like, representing the status of the posting regarding that member. For example, whether the posting has been opened, replied to, deleted, or the like. FIG. 6 is a diagrammatic representation of an exemplary embodiment of a member inbox table 600 which may be populated with records, or entries, of a post or set of posts present in an information exchange facility's member's inbox. In one embodiment, one such table is available for each member of the facility. The inbox table 600 may include a post identifier field or set of fields 602 that is generally associated with a unique identifier for a post, e.g., 402. The table 600 may also include a field or set of fields 604 for storing the status, or the like, of a post relative to said member.

In one embodiment, the database includes a table, set of tables, and/or fields, or the like, for recording, inter alia, transaction information. This information may include, for example, transaction type, credits, debits, and the like. FIG. 7 is a diagrammatic representation of an exemplary embodiment of a transaction table 700 which may be populated with records, or entries, regarding transactions performed through the exchange. The transaction table 700 may include a transaction identifying field or set of fields 702. Generally, each individual transaction is given a unique identifier. The transaction table 700 may also include a field or set of fields 704 linking a transaction to a unique identifier associated with a posting 402 or other transaction, such as, for example, a credit card transaction, a cash deposit, or the like. The transaction table 700 may also include a field or set of fields linking a transaction to a unique identifier associated with a specific type of transaction (e.g., a posting, access to a post, a deletion, a reply, a reply to all, a credit card transaction, and the like) (not shown). The transaction table 700 may also include a field or set of fields 706 linking a transaction to a unique identifier associated with an entity to be debited in the transaction. The entity may be a member, e.g., 302, or a non-member of the exchange. The transaction table 700 may also include a field or set of fields 708 linking a transaction to a unique identifier associated with an entity to be credited in the transaction. The entity may be a member, e.g., 302, or a non-member of the exchange, but will generally entail a member of the exchange. The transaction table 700 may also include a field or set of fields 710 with the value, unit based amount, or the like, exchanged in the transaction.

The database may include any other tables or fields that may be useful in the implementation of the information exchange facility, including storing information of non-members, credit-card numbers, and other such information. Account and transaction information for members and/or non-members may be kept separately, or generated on-the-fly or on demand. It will be appreciated by those of skill in the art that information other than that described above may populate the tables without loss of generality.

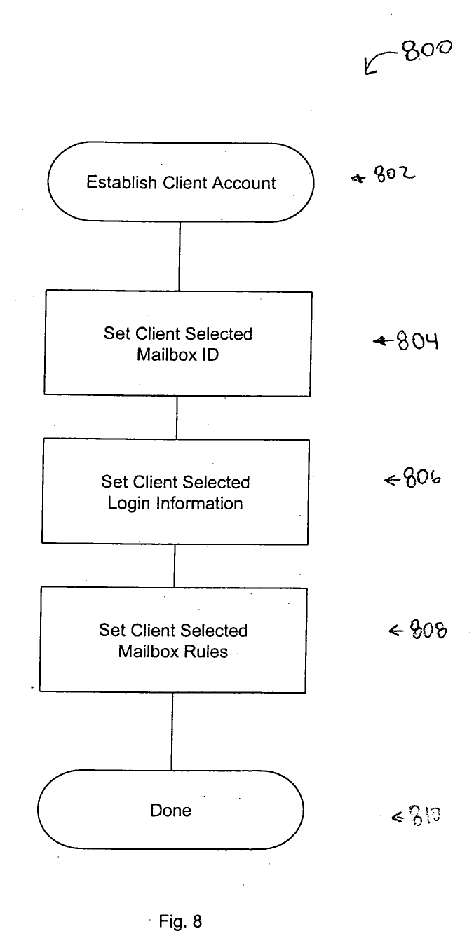

Any effective process may be used to establish a member account in accordance with the present invention. A flow diagram illustrating a representative process or routine 800 enabling the establishment of an account in accordance with an embodiment of the present invention is shown in FIG. 8. The account may be modified according to a similar process. Generally an account 802 may be established through a process comprising setting a client selected mailbox ID 804, or the like, linked to client selected login information 806 (e.g., a login ID, a password, or the like), and to client selected mailbox related rules 808, or the like. Generally, completion of the process 810, is followed by confirmation sent to the client containing information regarding the newly established account. While this and other processes are described herein as a specific sequence of steps, they generally perform in any effective sequence.

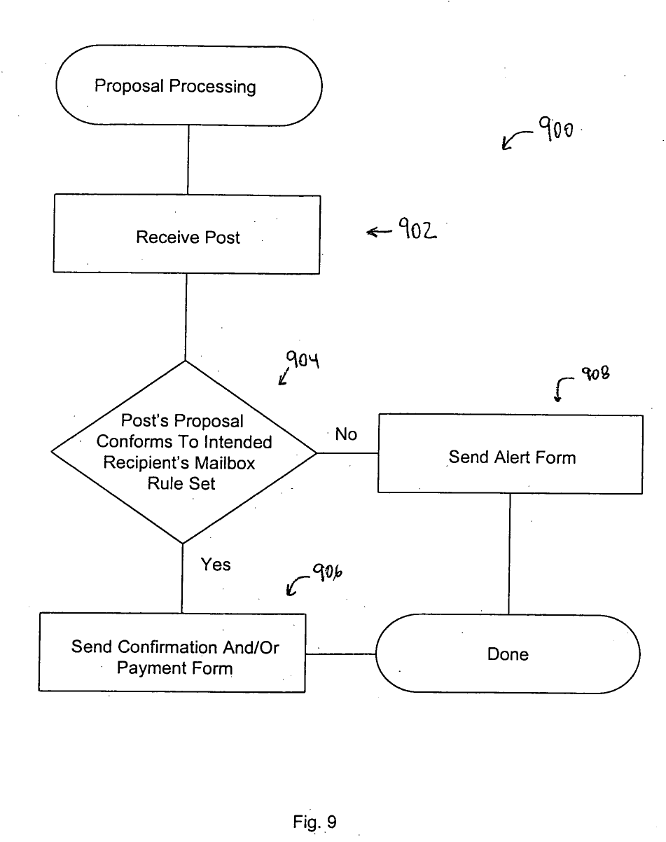

Any effective process may be used to process a post pursuant to a proposal linked thereto in accordance with an embodiment of the present invention. A flow diagram illustrating a process or routine 900 enabling post processing in accordance with an embodiment of the present invention is shown in FIG. 9. The process may be repeated as many times as necessary and/or required by the number of intended recipients. Upon receiving a post, a link to a post, or the like, 902 in accordance with the present invention, the process generally includes comparing the post's proposal 904 to the intended recipient's mailbox related rule set. In one embodiment, not shown, if the proposal conforms to the mailbox rule set, post distribution and credit accounting occur. Alternatively, as shown in routine 900, if the proposal conforms to the mailbox rule, set 904, a confirmation and/or payment form is sent to the client 906 for approval prior to post distribution and credit accounting. If the proposal does not conform to the mailbox rule set, any effective step may be taken. In one embodiment, shown in the FIG. 908 an alert form is sent to the entity attempting to send the post.

In another embodiment of the present invention a process or routine enabling post processing includes receiving a post, a link to a post, or the like, retrieving the addressee or set of addressees inbox rule or set of rules, sending a confirmation and/or payment form to the client, wherein the addressee or set of addressees inbox rule or set of rules is displayed for client approval prior to post distribution and credit accounting.

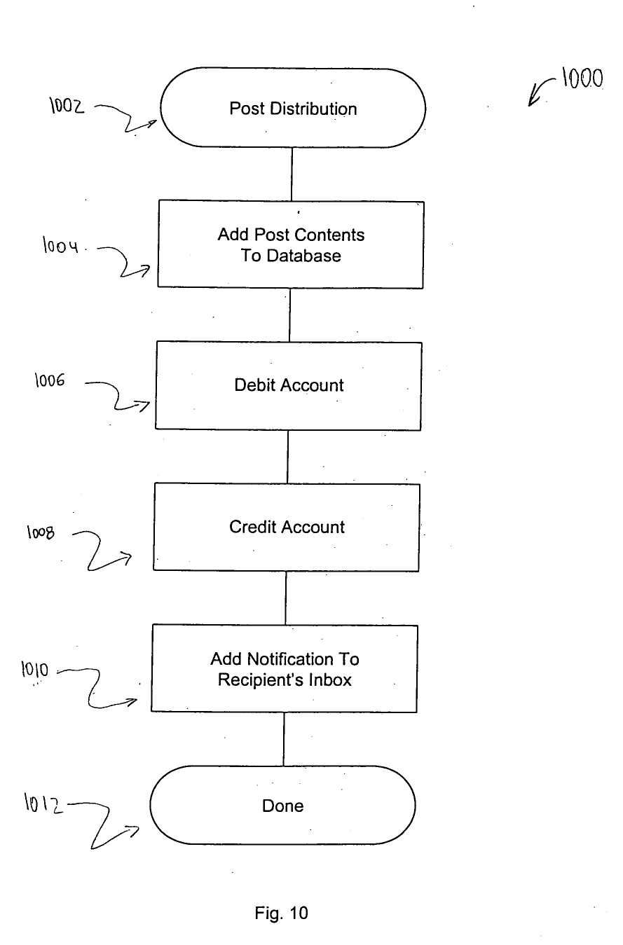

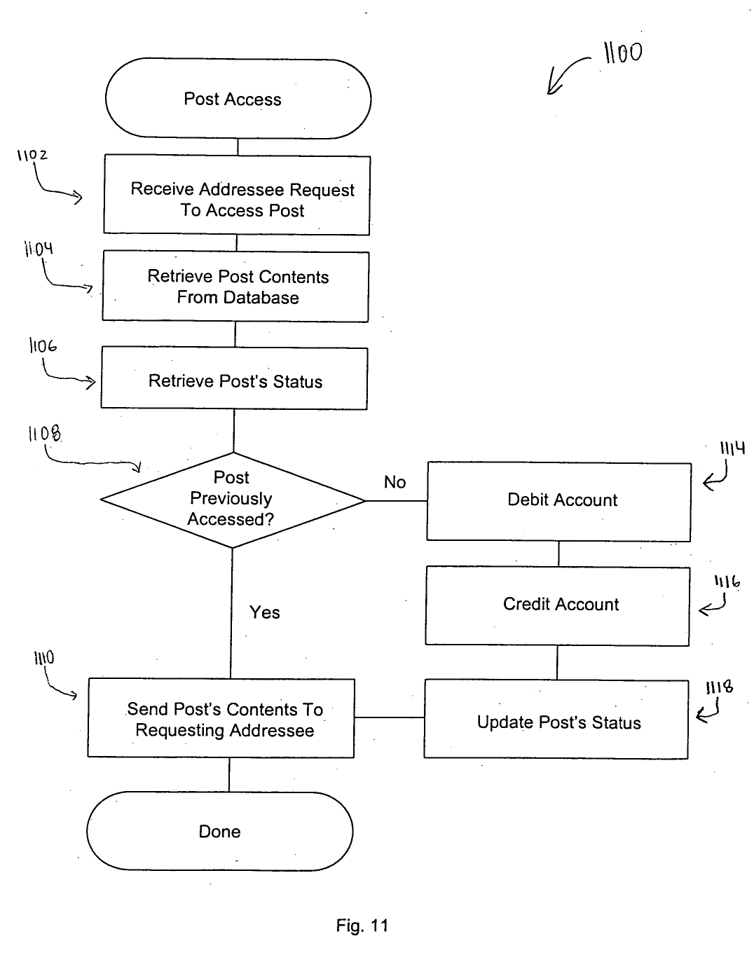

Any effective process may be used to implement post distribution and credit accounting in accordance with the present invention. A flow diagram illustrating a process or routine 1000 enabling post distribution and credit accounting in accordance with an embodiment of the present invention is shown in FIG. 10. Upon receiving an acceptable proposal and/or approval by the sender (e.g., 906) 1002, the contents of the post are added to a database 1004, an account is debited 1006 and another credited 1008, depending on the specific design used to implement the invention, pursuant to a post's proposal, the recipient's mailbox rule or other effective manner. A notification comprising the post, a link to the post, or the like, is added to each recipient's mailbox 1010. Generally, completion of the process 1012, may be followed by confirmation sent to the client containing information regarding the newly sent post (not shown).

Any effective process may be used to implement right-to-access a post in accordance with an embodiment of the present invention. A flow diagram illustrating a process or routine 1100 enabling post access by a recipient in accordance with an embodiment of the present invention is shown in FIG. 11. Upon receiving a request from a post's recipient for right to access a post 1102, the process retrieves the selected post's contents from the database 1104, or the like. In one embodiment, shown in the figure, the post's status is also retrieved 1106 and if the post's proposal was previously satisfied 1108, the post's contents are sent to the client 1110, but if the post's status indicates the proposal has not yet been satisfied 1108, an account is debited 1114 and another credited 1116, which may occur, depending on the specific design used to implement the invention, pursuant to a post's proposal, the recipient's mailbox rule or other effective manner. The status of the post is then generally updated to indicate the occurrence of the transaction 1118 and the post's contents are made available to the recipient 1110.

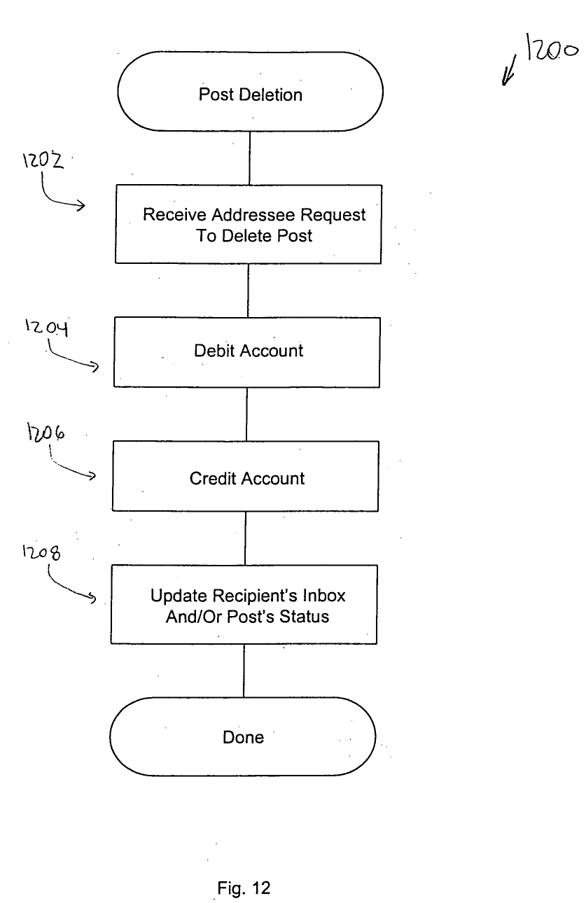

Any effective process may be used to delete a post from a recipient's inbox in accordance with an embodiment of the present invention. A flow diagram illustrating a process or routine 1200 enabling post deletion by a recipient in accordance with an embodiment of the present invention is shown in FIG. 12. Upon receiving a request from a post's recipient to delete a post 1202, an account is debited 1204 and another credited 1206, depending on the specific design used to implement the invention, pursuant to a post's proposal, the recipient's mailbox rule or other effective manner. Generally, the status of the post is updated to indicate the occurrence of the transaction 1208 and the recipient's inbox is updated to reflect absence of the post 1208.

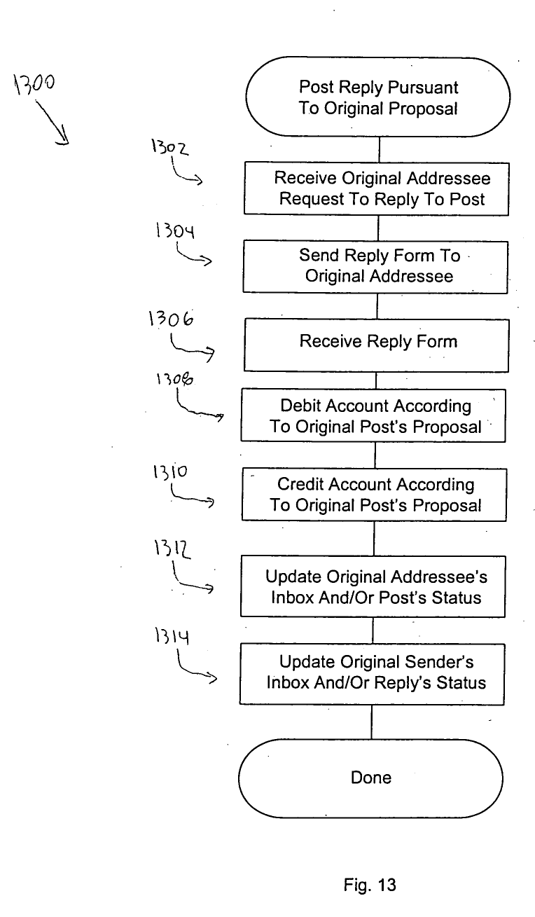

Any effective process may be used to process a request to reply to a post in accordance with the present invention. A flow diagram illustrating a process or routine 1300 enabling a reply pursuant to an embodiment of the present invention is shown in FIG. 13. Upon receiving a request from a post's original recipient to reply to a post 1302, a reply form, or the like, effectively linked to the original proposal, the recipient's mailbox rule or other effective manner, is sent to the original recipient 1304. Upon receiving the completed reply form 1306, an account is debited 1308 and another credited 1310 in accordance with the post's original proposal concerning replying to the original post. Generally, the status of the post is updated to indicate the occurrence of the transaction 1312 and the original sender's (e.g., recipient of the reply) inbox is updated to reflect the reply 1314. A similar process may be implemented to process a request to reply to all the addressees and the sender of a post.

In an embodiment of the present invention, a formatted proposal includes information that conforms to an effective set of conventions, such that it may, for example, be processed in a manner generally as described herein. In accordance with one embodiment of the present invention units of value are transferred in accordance with actions, or the like, specified in an accepted proposal. Unless otherwise required by the context, as used herein the term “transfer” means any effective transfer, including, for example an actual transfer, accounting for a transfer, or the like.

In accordance with another embodiment of the present invention a post is functionally linked to a formatted proposal.

In an embodiment, units of value are transferred upon posting. In an embodiment, upon posting the sender is debited and the addressee is credited with a value predetermined by the sender. In an embodiment, upon posting the sender is credited and the addressee is debited with a value predetermined by the sender. In an embodiment, upon posting the sender is debited and the addressee is credited with a value predetermined by the addressee. In an embodiment, upon posting the sender is credited and the addressee is debited with a value predetermined by the addressee.

In an embodiment, units of value are transferred upon opening or accessing a post. In an embodiment, when a post is accessed by an addressee the sender is debited and the addressee is credited with a value predetermined by the sender. In an embodiment, when a post is accessed by an addressee the sender is credited and the addressee is debited with a value predetermined by the sender. In an embodiment, when a post is accessed by an addressee the sender is debited and the addressee is credited with a value predetermined by the addressee. In an embodiment, when a post is accessed by an addressee the sender is credited and the addressee is debited with a value predetermined by the addressee.

In an embodiment, units of value are transferred upon deletion a post. In an embodiment, when a post is deleted by an addressee the sender is debited and the addressee is credited with a value predetermined by the sender. In an embodiment, when a post is deleted by an addressee the sender is credited and the addressee is debited with a value predetermined by the sender. In an embodiment, when a post is deleted by an addressee the sender is debited and the addressee is credited with a value predetermined by the addressee. In an embodiment, when a post is deleted by an addressee the sender is credited and the addressee is debited with a value predetermined by the addressee.

In an embodiment, units of value are transferred upon replying to post. In an embodiment, when an addressee replies to post the sender is debited and the addressee is credited with a value predetermined by the sender. In an embodiment, when an addressee replies to post the sender is credited and the addressee is debited with a value predetermined by the sender. In an embodiment, when an addressee replies to post the sender is debited and the addressee is credited with a value predetermined by the addressee. In an embodiment, when an addressee replies to post the sender is credited and the addressee is debited with a value predetermined by the addressee.

In an embodiment, units of value are transferred upon replying to all. Embodiments include all effective combinations, including, for example, permutations between original sender, original recipient that is replying and original recipient who is receiving reply from sending original recipient.

In another embodiment, the present invention provides a combination, or set, of input fields and other information. Unless otherwise required by the context, as used herein the term input field generally encompasses a field that queries an entity, client, user, or the like, and permits the entity to enter data at a client machine, or the like, and upload it to a server, or the like. For example, in HTML the tags <form>, <input type>, <textarea>, <href>, and others, when properly used generate input fields.

A combination, or set, of input fields in accordance with the present invention may be presented or displayed in any effective manner. These include, for example, a single screen, or the like, or sequences of screens, or the like. Screens or pages used to implement the present invention may have any effective design. Some embodiments of the present invention include some but not all of the functionality described herein. In case a field, entry, or the like, or other information is not necessary in the implementation of an embodiment of the present invention, the field, entry or the like, and/or other information may be omitted.

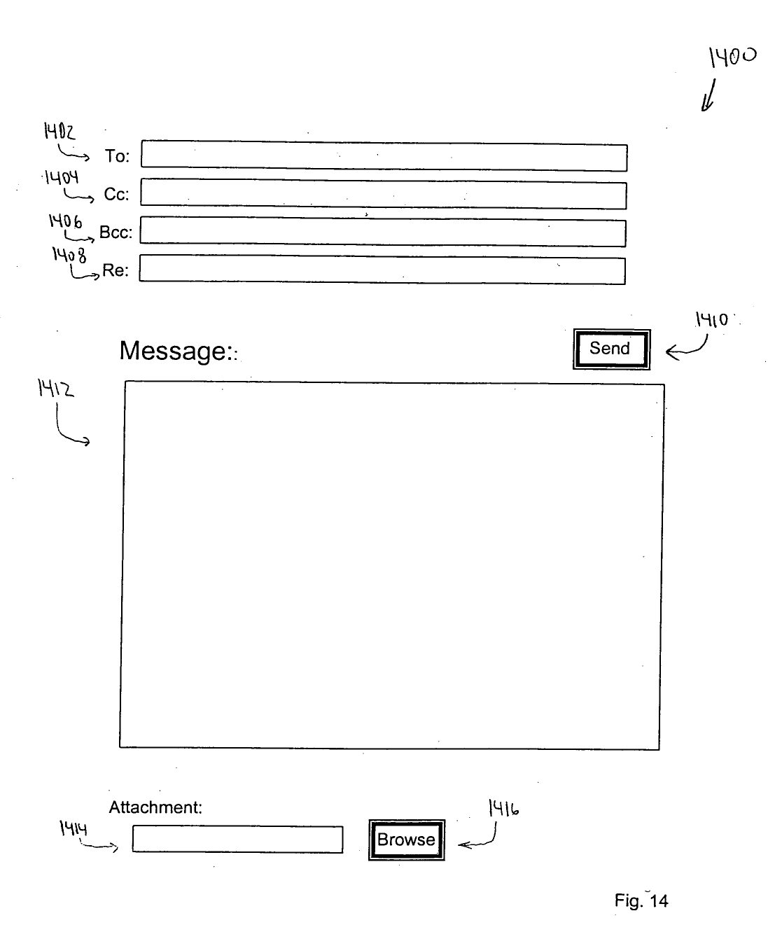

Any effective combination of input fields and other information may be used to generate a post in accordance with the present invention. A diagram illustrating a generic combination of input fields 1400 that may be used to generate a post is shown in FIG. 14. Input fields 1402, 1404, 1406 permit the input of addressee data. Input field 1408 permits the input of a subject line, or the like. A submit button, or the like, 1410 permits submission of the form 1400, or the like. Input field 1412 permits the input of information, including, for example, text, or the like. Input field 1414 permits the input of a file attachment, set of attachments, or the like. A browse button, or the like, 1416 permits selecting a file to be attached.

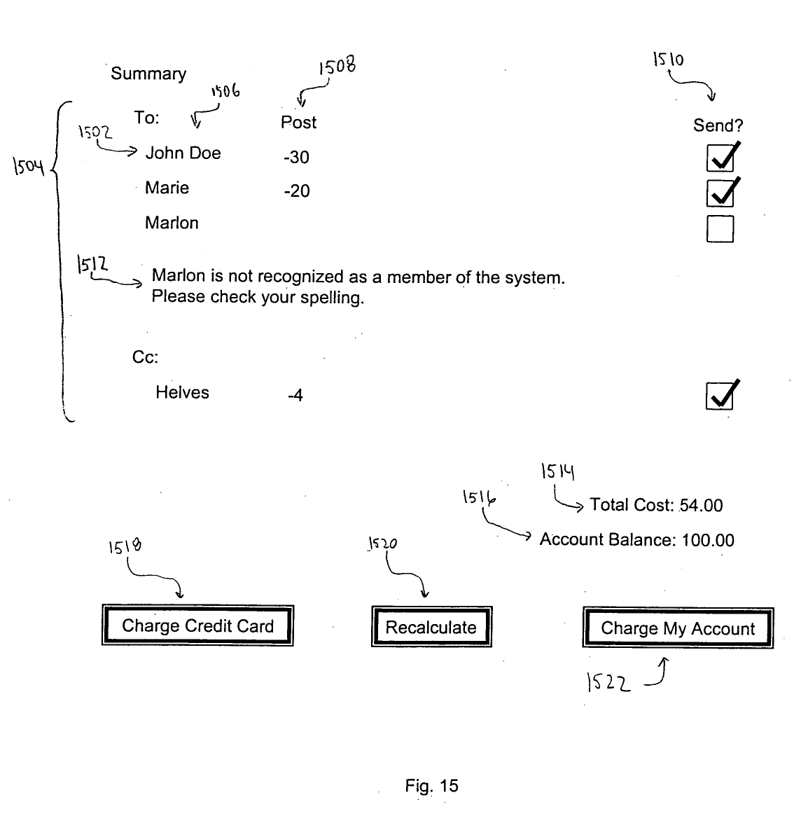

Any effective combination of input fields and other information may be used to generate a confirmation and/or payment form in accordance with the present invention. A diagram illustrating an embodiment of the present invention including combination of input fields and other information 1500 that may be used to generate a confirmation and payment form in accordance with the present invention is shown in FIG. 15. An addressee line 1502, or set of lines 1504, includes an addressee 1506, the cost to post to the addressee 1508 and a check-box, or the like, 1510 which permits selecting or deselecting an addressee. The form may further include a notice 1512, or set of notices, or the like, when necessary. The form may further include a field or set of fields that permits entering a further addressee or set of addressees (not shown). The form further includes a tally of the cost 1514 and the sender's account balance 1516, or the like. Submit buttons 1518, 1520, 1522, permit the user to select a method of payment 1518, 1522, or to recalculate 1520, e.g., the cost if addressee(s) have been added or deselected. Any, all, or any effective combination of these fields may be present in accordance with different embodiments of the present invention.

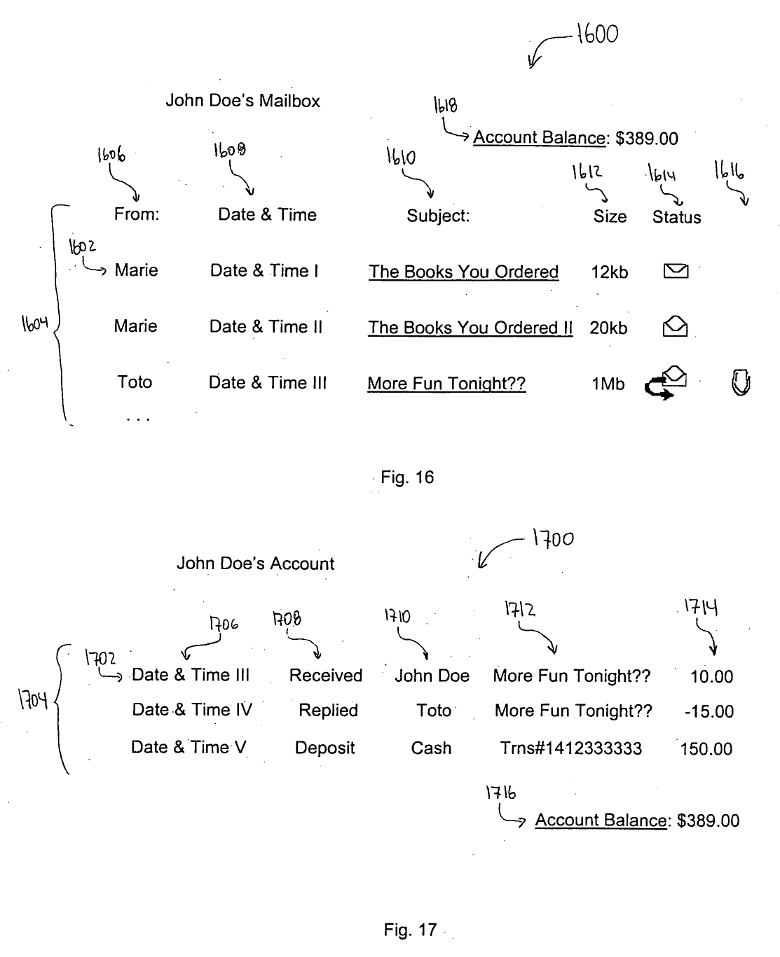

Any effective combination of input fields and other information may be used to generate an interface that permits a member to access posts and otherwise manage its account in accordance with the present invention. A diagram illustrating a combination of input fields 1600 that may be used as a mailbox in accordance with the present invention is shown in FIG. 16. A line 1602, or set of lines 1604, for each received and not yet deleted post includes a sender identification 1606, a date generally corresponding to the date the post was received 1608, a post identifier, or the like, 1610 which may be designed to permit accessing the post (e.g., via a hyperlink, or the like), an indicator for the size of the post 1612, an indicator for the status of the post 1614, an indicator of the presence of attachments 1616. In accordance with an embodiment of the present invention, the mailbox includes the member's account balance 1618. The account balance generally permits accessing a page, or the like, with account transaction information, or the like. Any, all, or any effective combination of these fields may be present in accordance with different embodiments of the present invention.

Any effective combination of input fields and other information may be used to generate an interface that permits a member to view account transaction information in accordance with the present invention. A diagram illustrating a combination of fields 1700 that may be used as an account page in accordance with the present invention is shown in FIG. 17. A line 1702, or set of lines 1704, for each transaction generally includes a transaction date 1706, a transaction type indicator 1708, an origin or destination for the value transferred 1710, a transaction identifier 1712 and a value transferred in the transaction 1714. The account page may generally also include a member's account balance 1716. Any, all, or any effective combination of these fields may be present in accordance with different embodiments of the present invention.

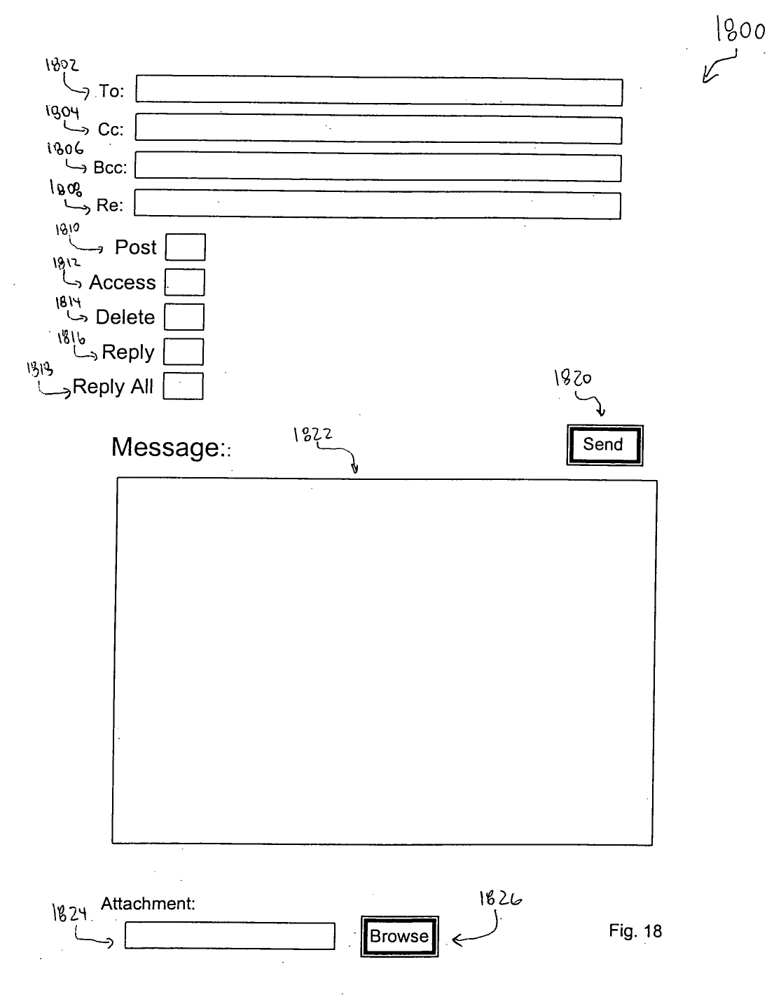

A diagram illustrating a combination of input fields 1800 that may be used to generate a post in accordance with an embodiment of the present invention is shown in FIG. 18. Input fields 1802, 1804, 1806 permit the input of addressee data. Input field 1808 permits the input of a subject line, or the like. Input field 1810 permits the input of a proposed value to be credited/debited upon posting to an (e.g., each) addressee or set of addressees in accordance with an embodiment of the present invention. Input field 1812 permits the input of a proposed value to be credited/debited upon access to the post by an (e.g., each) addressee or set of addressees in accordance with an embodiment of the present invention. Input field 1814 permits the input of a proposed value to be credited/debited upon deletion of the post by an (e.g., each) addressee or set of addressees in accordance with an embodiment of the present invention. Input field 1816 permits the input of a proposed value to be credited/debited upon reply of the post by an (e.g., each) addressee or set of addressees in accordance with an embodiment of the present invention. Input field 1818 permits the input of a proposed value to be credited/debited upon reply to all accordance with an embodiment of the present invention. A submit button, or the like, 1820 permits submission of the form 1800, or the like. Input field 1822 permits the input of information, including, for example, text, code, or the like. Input field 1824 permits the input of a file attachment, set of attachments, or the like. A browse button, or the like, 1826 permits selecting a file to be attached. Any, all, or any effective combination of these fields may be present in accordance with different embodiments of the present invention.

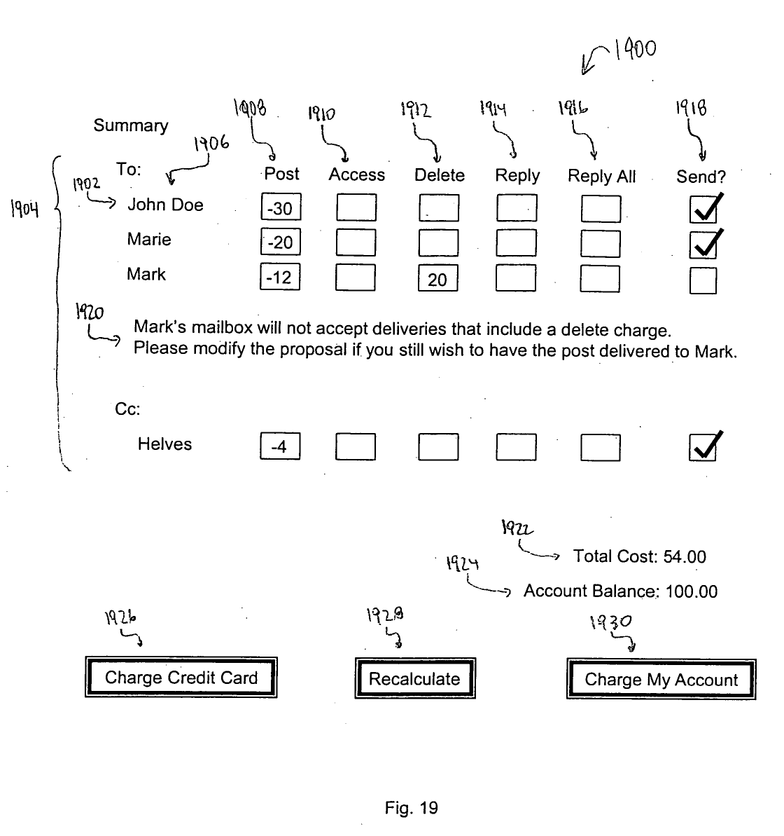

A diagram illustrating a combination of input fields and other information 1900 that may be used to generate a confirmation and payment form in accordance with another embodiment of the present invention is shown in FIG. 19. An addressee line 1902, or set of lines 1904, includes an addressee 1906 and a set of input fields 1908, 1910, 1912, 1914, 1916 for proposed value(s) to be credited/debited upon posting 1908, access of the post by the addressee 1910, deletion of the post by the addressee 1912, reply of the post by the addressee 1914, and reply to all 1916. The embodiment shown in the figure further includes a check-box, or the like, 1918 that permits selecting or deselecting the addressee. As shown in the figure, the form may further include a notice 1920, or set of notices, or the like, when necessary. The form may further include a field or set of fields that permits entering a further addressee or set of addressees (not shown). The form further includes a tally of the cost 1922 and the sender's account balance 1924, or the like. Submit buttons 1926, 1928, 1930, permit the user to select a method of payment 1926, 1930, or to recalculate 1928, e.g., the cost if addressee(s) have been added or deselected. Any, all, or any effective combination of these fields may be present in accordance with different embodiments of the present invention.

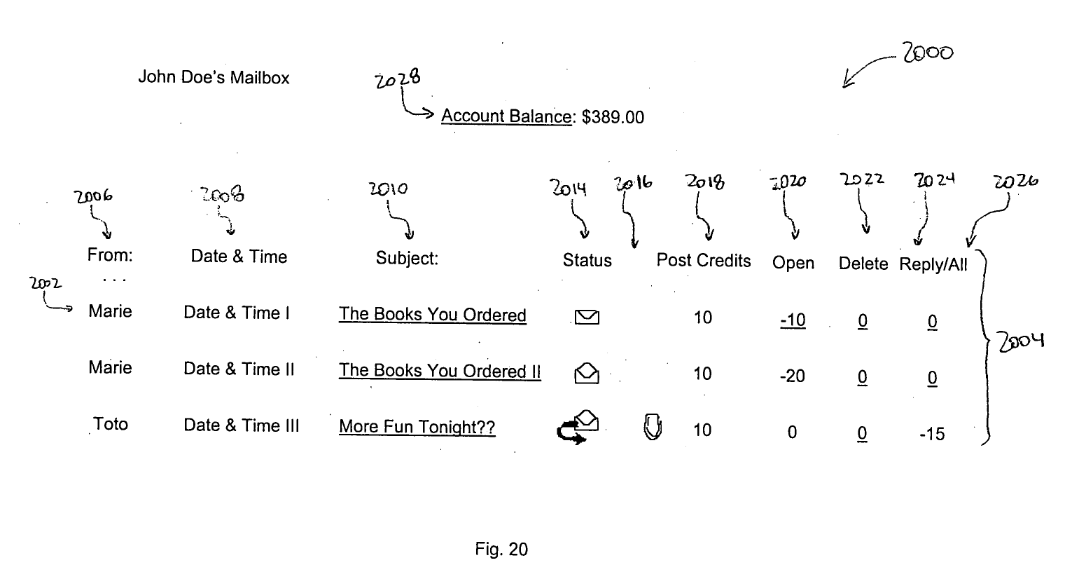

A diagram illustrating a combination of input fields and other information 2000 that may be used as a mailbox in accordance with another embodiment of the present invention is shown in FIG. 20. A line 2002; or set of lines 2004, for each received and not yet deleted post includes a sender identification 2006, a date generally corresponding to the date the post was received 2008, a post identifier, or the like, 2010 which may be designed to permit accessing the post (e.g., via a hyperlink, or the like), an indicator for the size of the post (not shown), an indicator for the status of the post 2014, an indicator of the presence of attachments 2016. In accordance with an embodiment of the present invention, the line 2002 further includes the value credited/deleted from receipt of the post 2018. In accordance with an embodiment of the present invention, the line 2002 further includes a value to be credited/debited upon accessing the post 2020. The value may include a link to a process that will access the post and may be coded (e.g., color coded) to indicate whether a credit/debit will occur if the post is accessed. In accordance with an embodiment of the present invention, the line 2002 further includes a value to be credited/debited upon deleting the post 2022. The value 2022 may include a link to a process that will delete the post and may be coded (e.g., color coded) to indicate whether a credit/debit will occur if the post is deleted. In accordance with an embodiment of the present invention, the line 2002 further includes a value to be credited/debited for replying 2024/replying to all 2026. The value 2024, 2026, may include a link to a process that will provide a reply form and may be coded (e.g., color coded) to indicate whether or not the credit/debit will occur if the post is replied/replied to all. In accordance with an embodiment of the present invention, the mailbox includes the member's account balance 2028. The account balance generally permits accessing a page, or the like, with account transaction information, or the like. Any, all, or any effective combination of these fields may be present in accordance with different embodiments of the present invention.

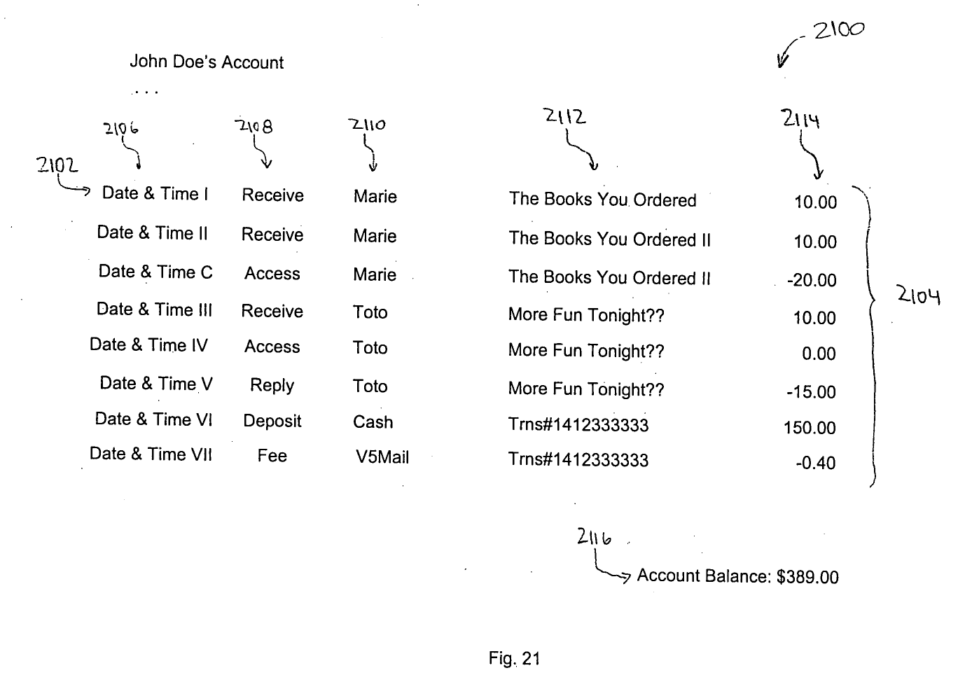

A diagram illustrating a combination of fields 2100 that may be used as an account page in accordance with another embodiment of the present invention is shown in FIG. 21. A line 2102, or set of lines 2104, for each transaction generally includes a transaction date 2106, a transaction type indicator 2108, an origin or destination for the value transferred 2110′, a transaction identifier 2112 and a value transferred in the transaction 2114. The account page further includes the member's account balance 2116. Any, all, or any effective combination of these fields may be present in accordance with different embodiments of the present invention.

The figures herein merely illustrate possible formats for presenting information in accordance with the present invention. However, pages (including screens, and the like) may present information in any effective format in accordance with the present invention. The pages may also include further information. For example, the pages may further include navigational menus, bars, buttons, and the like, action menus, bars, buttons, and the like, combinations thereof, and the like. In addition, information may be omitted as long as the information present is effective for the purpose intended in accordance with an embodiment of the present invention.

Certain examples provided herein to illustrate some embodiments of the present invention assume enough funds are available to cover a transaction. Those of ordinary skill in the art will appreciate that may not always be the case, and of appropriate measures that may be taken when adequate funds, or the like, are not available.

While it is generally omitted from the description of the present invention, those of skill in the art will recognize that in certain embodiments a transaction fee, or the like, may be assessed without detracting from the overall spirit of the invention.

Embodiments of the present invention may be used in any effective manner.

In one embodiment, for example, a user may generally become a member by pointing a browser or the like to the address of the system in a network and filing out a form, set of forms, or the like, which generally require the selection of an effective member ID, an effective password and an effective set of rules for the member's inbox.

A system in accordance with the present invention may permit different complexities as to the rules a member may set for its inbox. In a simple example, the member may set a value that it will be credited every time a sender places a post in the member's inbox. More complex rules and/or conditions in accordance with other embodiments of the present invention permit more intricate rules and/or conditions.

Proposals in accordance with the present invention may generally be in any effective form. For example, they may be explicit, implicit on a set of rules and conditions, and combinations thereof. In an embodiment of the invention, a proposal may include a value the addressee is credited or debited for receiving the post. In an embodiment of the invention, a proposal may include a value the addressee is credited or debited for accessing the post. In an embodiment of the invention, the proposal may include a value the addressee is credited or debited for deleting a post. In an embodiment of the invention, the proposal may include a value the addressee is credited or debited for replying to a post. In an embodiment of the invention, the proposal may include a value the addressee is credited or debited for replying to all. In an embodiment, a proposal may include combinations thereof.

In addition, the proposal and the corresponding rules may include time sensitive actions. For example, a proposal may indicate that a post can be accessed free of charge for a specified amount of time, 5 days for example, at which time it will automatically be deleted, or alternatively, after which time there will be a charge for accessing it. In another example, a proposal may indicate that a post can be accessed for a specific charge for a specified amount of time, 5 days for example, after which time there will be no charge for accessing it.

In another example, the proposal may indicate that the posting can be deleted at no charge as long as the post was not previously accessed by the addressee, but will incur a specific charge if the post has been accessed by the addressee. In another example, a proposal may indicate that a posting can be deleted free of charge after a specified amount of time, 30 days for example, but will require a charge if deleted before that time. In another example, the proposal may indicate that the posting can be deleted at no charge as long as the addressee has replied to the post. These of course are merely representative examples. Any effective proposal may be created in accordance with the present invention.

Reciprocally, in accordance with an embodiment of the present invention, mailbox rules may be established by members requiring posts to satisfy any of a set of conditions. In accordance with variations within the scope of the present invention a member may set any rules permitted by the system for their inbox. Conditions generally include at least one rule relating to the credit and or debit of units of value in accordance with an embodiment of the present invention. Posts not meeting a member's inbox set of rules and/or conditions may, for example, be barred from, or denied access to, said member's inbox.

Rules and conditions may be in absolute terms, relative terms, or combinations thereof. For example, a mailbox rule may require the transfer of a pre-set value to accept a post. In another example, a mailbox rule may bar posts that would result in a credit to the addressee lower than a certain amount of units of value, for example, ten units. In another example, a mailbox rule may bar posts that will result in a credit to the addressee greater than a certain amount of units of value, for example, ten thousand units. In another embodiment, a mailbox rule may bar posts that will result in a credit lower than a certain amount of units of value, for example, ten units or in a credit greater than a certain amount of units of value, for example, ten thousand units. In another example, a rule may bar posts having a proposal requiring a charge to the addressee greater than a certain value for accessing the post. In another example, a rule may bar posts having a proposal requiring a charge to the addressee greater than a certain value for the deletion of the post. In another other example, a rule may bar posts having a proposal requiring a charge to the addressee greater than a certain value for replying to the post and/or “replying to all.” In another embodiment, a rule may require that a post's proposal include a credit for posting that is greater than the addition of the cost of accessing and deleting the post. In another embodiment, a rule will not accept posts that charge more for opening than the value credited to post the information, or by specifying some difference, i.e., within +, −, or both, units, or x % of the value, or the like, to post the information to said member. These of course are merely representative examples. The present invention makes possible the implementation of numerous other combinations and variations.

Mailbox setup, postings, crediting and debiting units of value in accordance with the present invention may be done in any effective manner. Generally, once a mailbox has been set up (e.g., 800), the member may receive (e.g., 900, 1000), access (e.g., 1100), delete (e.g., 1200) and reply (e.g., 1300) to a post and may be credited and debited units of value in accordance with the present invention.

A post may be drafted in any effective manner in accordance with the present invention. In one embodiment, a prospective sender, through a browser or the like, requests and receives a form, or the like, from the system. Any effective form may be used. Generally, the form will depend on the implementation of inbox rules in the specific system. In one embodiment, wherein the only action permitted is crediting an addressee's account a value pre-specified by the addressee, the form generally includes an addressee field, and may further include a field or set of fields for the input of information to be transmitted to said addressee (e.g., 1400). In other embodiments, the form generally includes an addressee field, and may further include any field or set of field, providing, for example, for the input of specific values for posting the information to the addressee, access to a post by the addressee, deletion of a post by the addressee, reply of a post by the addressee, dates for actions, and any other field or combination of fields consistent with the present invention (e.g., 1800).

In one embodiment of the present invention, an entity may generally place a post in an addressee's inbox by satisfying, having a proposal that satisfies, or the like, the addressee's inbox rules.

Upon submission of the form by the sender, the system will generally compare the proposal in the submitted post to the inbox rules for the addressee. In one embodiment, which only permits crediting an addressee's account a value pre-specified by the addressee, it may be implied that the sender proposes to credit the addressee's account said value. In this embodiment, if the system is so set up, the sender may be automatically debited for the posting. Alternatively, in another embodiment, the system may send a confirmation request (e.g., 1500, 1900) to the sender, informing the sender of the cost of the transaction, addressee inbox rules, and the like, and requesting confirmation and/or payment. For example, if the sender is a member with enough credits to cover the transaction, the system may present a button with the option of charging the sender's account. If the units of value are monetary, the system may present the sender with an option to pay for the transaction using a credit card, debit card, or any other effective form of payment available to the system. Generally, non-members and/or members not having enough credits to cover the transaction will be allowed only the latter form of payment.

In one embodiment, where the system sends a confirmation request to the sender, the form may further include selection boxes, or the like, that permit the sender to select in or out intended addressees. The form may also include a field or set of fields that permits the inclusion of further intended addressees. The form may also include a “recalculate” button, or the like, which recalculates the total after the addition an d/or subtraction of intended addressees. Alternatively, when possible the recalculation may be performed “on the fly” at the client using JAVA, or the like. The form may also include error messages and notifications. In general, any effective notification may be provided by the system. In one embodiment the message may include a notification when an intended recipient is not recognized by the system. In systems permitting complex rules, the message may, for example, notify the sender of shortcomings or failures of a proposal with respect to the rules and requirements of an addressee.

Upon receipt by the system of a post directed to an addressee including a proposal acceptable to the inbox of said addressee, depending on the system either directly or via a confirmation form, the system will generally store the post and make it available to the addressee. In addition, the system will take any action or set of actions required by the proposal.

Members may generally access their account and/or the contents of posts in their mailboxes in any effective manner. In one embodiment, members may log on to the system, and thus be given access to the information. A member's inbox (e.g., 1600, 2000) may include any of a number of features that may prove useful for its functionality. Generally, the inbox will include a list, or the like, wherein the list includes identifying characteristics of posts received while providing a link or the like to the information of the received posts. Generally a member will access a post by clicking on the post's link. The inbox may contain other features in accordance with other embodiments of the present invention. In addition to a status field, in accordance with an embodiment of the present invention a field may be present indicating the value credited or assessed to the recipient's account when the post was posted.

In another embodiment of the present invention, the inbox includes a field indicating the value to be credited or assessed if the recipient accesses the post. In one embodiment, the field provides a link to the post.

In another embodiment of the present invention, the inbox includes a field indicating the value to be credited or assessed if the recipient deletes the post. In one embodiment, by clicking the field a recipient may delete the post from the inbox.

In another embodiment of the present invention, the inbox includes a field indicating the value to be credited or assessed if the recipient replies to the post. In one embodiment, by clicking the field a recipient may obtain a form for replying to the post in accordance with the indicated value.

In another embodiment of the present invention, the inbox includes a field indicating the balance in the account. In one embodiment, by clicking the field a recipient may obtain a list with information regarding account activity.

Members may generally view account activity in any-effective manner. In one embodiment, members may log on to the system, and thus be given access to the information via an account page, or the like (e.g., 1700, 2100). A member's account page may include any of a number of features that may prove useful for its functionality. Generally, an account page permits a user to view a number of facts relating to a transaction including, for example, a transaction date, a transaction type, an origin or destination for the value transferred, a transaction identifier and the value transferred in the transaction. A member's account balance is generally also shown.

The present invention has been described in relation to particular embodiments which are intended in all respects to be illustrative rather than restrictive. Alternative embodiments will become apparent to those skilled in the art to which the present invention pertains without departing from its spirit and scope. Accordingly, the scope of the present invention is defined by the appended claims rather than the foregoing description.

1. A post comprising information identifying an intended recipient functionally linked to a formatted proposal.

2. The post of claim 1 wherein the formatted proposal comprises an offer to transfer units of value from a first entity to a second entity pursuant to said formatted proposal.

3. The post of claim 2 wherein the formatted proposal comprises an offer to transfer units of value from a first entity to a second entity upon receipt of said post.

4. The post of claim 2 wherein the formatted proposal comprises an offer to transfer units of value from a first entity to a second entity upon access to the post by the recipient.

5. The post of claim 2 wherein the formatted proposal comprises an offer to transfer units of value from a first entity to a second entity upon deletion of the post by the recipient.

6. A method for monetizing transfer of information, said method comprising:
storing a first value comprising an identifier for a first entity;
storing a second value comprising an entity specific unit based amount, wherein said second value is linked to said first value;
receiving information from a second entity, wherein the information comprises an addressee comprising said first value;
transferring a unit based amount comprising said second value from the second entity to the first entity;
posting the received information to said first entity.

7. The method of claim 6, wherein the information further comprises a second entity specific unit based amount specified by the second entity, said method further comprising:
transferring a unit based amount comprising said second entity specific unit based amount from the first entity to the second entity upon an action comprising access to said information by said first entity.

8. The method of claim 6, wherein the information further comprises a second entity specific unit based amount specified by the second entity, said method further comprising:
transferring a unit based amount comprising said second entity specific unit based amount from the first entity to the second entity upon an action comprising deletion of said information by said first entity.

9. The method of claim 6, wherein the information further comprises a second entity specific unit based amount specified by the second entity, said method further comprising:
transferring a unit based amount comprising said second entity specific unit based amount from the first entity to the second entity upon an action comprising reply to such information by said first entity.

10. A system comprising a processor functionally linked to a storage element and a network, wherein the storage element comprises a database, the database further comprising
a) a record comprising a first value comprising an identifier for a first entity,
b) a second value comprising an entity specific unit based amount, wherein said second value is linked to said first value,
c) a transaction table, and
d) a post table,
wherein upon receipt by the processor via a network of a post from a second entity addressed to the first entity, the processor performs a method comprising storing the post in the post table and recording a transaction in the transaction table, wherein the transaction recorded comprises a third value comprising the first entity, a fourth value comprising the second entity, and a fifth value comprising a link to the stored post.
